(19) United States
(12) Patent Application Publication
(10) Pub. No.: US 2022/0361247 A1
(43) Pub. Date: Nov. 10, 2022

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Vivek SHARMA, Basingstoke (GB); Samuel Asangbeng ATUNGSIRI, Basingstoke (GB); Yuxin WEI, Basingstoke (GB)

(73) Assignee: Sony Group Corporation, Tokyo (JP)

(21) Appl. No.: 17/624,354

(22) PCT Filed: Jun. 30, 2020
(86) PCT No.: PCT/EP2020/068360

§ 371 Date: Jan. 3, 2022

(30) Foreign Application Priority Data
Jul. 11, 2019 (EP) 19185684.8

(51) Int. Cl. H04W 74/08; H04L 5/00

(52) U.S. Cl. CPC H04W 74/0833; H04L 5/0048; H04L 5/0055; H04L 5/0044

(57) ABSTRACT

A method for transmitting data or receiving data by a communications device is provided. The method comprises transmitting a first signal comprising a random access preamble and a first portion of uplink data, receiving a second signal comprising a random access response in response to the first signal, and transmitting, in response to receiving the second signal, a third signal comprising a second portion of uplink data. The second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the third signal.

### BACKGROUND

### Field of Disclosure

The present disclosure relates to communications devices which are configured to transmit data to and receive data from infrastructure equipment of a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will be expected to routinely and efficiently support communications with a wider range of devices associated with a wider range of data traffic profiles and types than current systems are optimised to support. For example it is expected future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles.

One example of a new service is referred to as Ultra Reliable Low Latency Communications (URLLC) services which, as its name suggests, requires that a data unit or packet be communicated with a high reliability and with a low communications delay. URLLC type services therefore represent a challenging example for both LTE type communications systems and 5G/NR communications systems.

The increasing use of different types of network infrastructure equipment and terminal devices associated with different traffic profiles give rise to new challenges for efficiently handling communications in wireless communications systems that need to be addressed.

### SUMMARY OF THE DISCLOSURE

The present disclosure can help address or mitigate at least some of the issues discussed above.

A first embodiment of the present technique can provide a method for transmitting data or receiving data by a communications device. The method comprises transmitting a first signal comprising a random access preamble and a first portion of uplink data, receiving a second signal comprising a random access response in response to the first signal, and transmitting, in response to receiving the second signal, a third signal comprising a second portion of uplink data. The second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the third signal.

A second embodiment of the present technique can provide a method for transmitting data or receiving data by a communications device. The method comprises determining an acknowledgement identifier in accordance with predefined information known by the communications device, transmitting a first signal comprising uplink data, and monitoring for reception of a Downlink Control Information, DCI, signal having the determined acknowledgement identifier. Either: the DCI signal comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the first signal; or the DCI signal comprises one or more ACK/NACKs, wherein one of the one or more ACK/NACKs is for reception by the communications device in response to the transmission of the first signal.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is a schematic representation illustrating steps in a four-step random access (RACH) procedure in a wireless telecommunications network;

FIG. 5 is a schematic representation illustrating an example of uplink data transmission of a communications device in RRC_INACTIVE mode with a downlink response from the network;

FIG. 6 is a schematic representation illustrating an example four-step RACH procedure which could be applied for transmissions of small amounts of data;

FIG. 7 is a schematic representation illustrating an example two-step RACH procedure which could be applied for transmissions of small amounts of data;

FIG. 8 is a schematic representation illustrating steps in a two-step RACH procedure in a wireless telecommunications network;

FIGS. 9A and 9B provide two examples of the two-step RACH procedure having uplink data transmissions after msgB;

FIG. 10 is a part schematic representation, part message flow diagram of communications between a communications device and an infrastructure equipment of a wireless communications network in accordance with a first embodiment of the present technique;

FIG. 11 is a part schematic representation, part message flow diagram of communications between a communications device and an infrastructure equipment of a wireless communications network in accordance with a second embodiment of the present technique;

FIG. 12 provides an example of a two-step RACH procedure having both uplink and downlink resource allocations in accordance with the first embodiment of the present technique;

FIG. 13 illustrates bit sequences corresponding to physical resource block indices in a bandwidth part in accordance with embodiments of the present technique;

FIG. 14 shows a first flow diagram illustrating a process of communications between a communications device and an infrastructure equipment in accordance with the first embodiment of the present technique; and

FIG. 15 shows a second flow diagram illustrating a process of communications between a communications device and an infrastructure equipment in accordance with the second embodiment of the present technique.

### DETAILED DESCRIPTION OF THE EMBODIMENTS

### Long Term Evolution Advanced Radio Access Technology (4G)

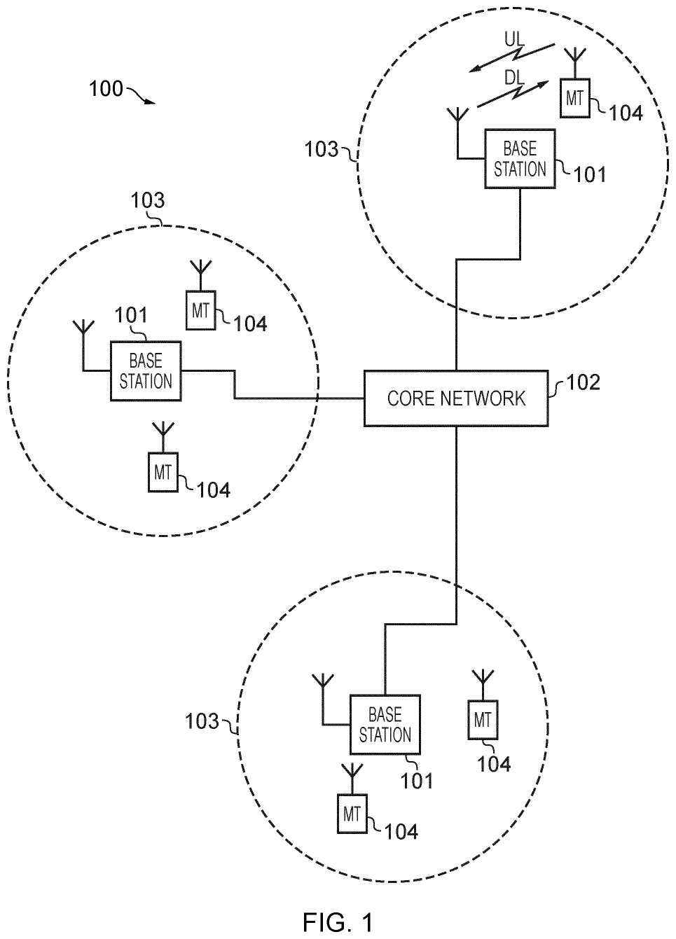

FIG. 1 provides a schematic diagram illustrating some basic functionality of a mobile telecommunications network/system 10 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications (or simply, communications) networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 (i.e. a cell) within which data can be communicated to and from terminal devices 104. Data is transmitted from base stations 101 to terminal devices 104 within their respective coverage areas 103 via a radio downlink (DL). Data is transmitted from terminal devices 104 to the base stations 101 via a radio uplink (UL). The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs/eNBs/g-nodeBs/gNBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

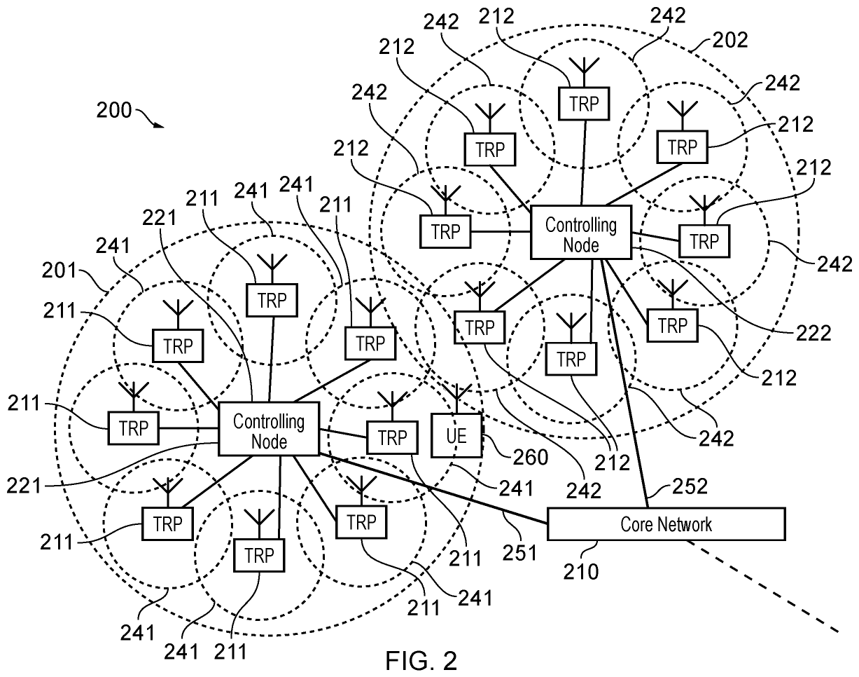

FIG. 2 is a schematic diagram illustrating a network architecture for a new RAT or new radio (NR) wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

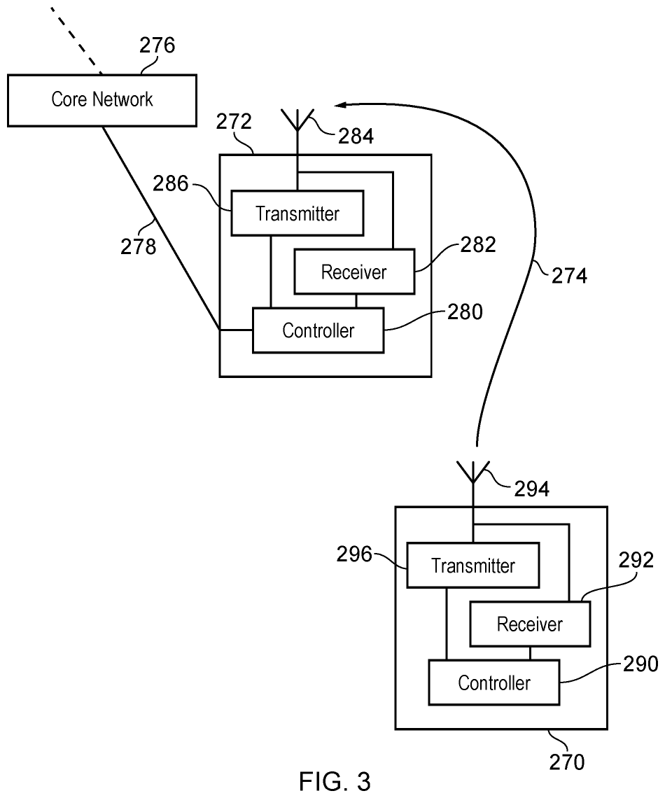

A more detailed illustration of a UE 270 and an example network infrastructure equipment 272, which may be thought of as a gNB 101 or a combination of a controlling node 221 and TRP 211, is presented in FIG. 3. As shown in FIG. 3, the UE 270 is shown to transmit uplink data to the infrastructure equipment 272 via resources of a wireless access interface as illustrated generally by an arrow 274. The

UE 270 may similarly be configured to receive downlink data transmitted by the infrastructure equipment 272 via resources of the wireless access interface (not shown). As with FIGS. 1 and 2, the infrastructure equipment 272 is connected to a core network 276 via an interface 278 to a controller 280 of the infrastructure equipment 272. The infrastructure equipment 272 includes a receiver 282 connected to an antenna 284 and a transmitter 286 connected to the antenna 284. Correspondingly, the UE 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the UE 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Bandwidth Parts (BWP)

A communications device and an infrastructure equipment, such as the communications device 104 and infrastructure equipment 101 of FIG. 1 or the communications device 260 and infrastructure equipment (TRP) 211, 212 of FIG. 2, are configured to communicate via a wireless access interface. The wireless access interface may comprise one or more carriers, each providing, within a range of carrier frequencies, communications resources for transmitting and receiving signals according to a configuration of the wireless access interface. The one or more carriers may be configured within a system bandwidth provided for the wireless communications network of which the infrastructure equipment 101, 211, 212 forms part. Each of the carriers may be divided in a frequency division duplex scheme into an uplink portion and a downlink portion and may comprise one or more bandwidth parts (BWPs). A carrier may be configured therefore with a plurality of different BWP for a communications device to transmit or receive signals. The nature of the wireless access interface may be different amongst the different BWPs. For example, where the wireless access interface is based on orthogonal frequency division multiplexing, different BWPs may have different sub-carrier spacing, symbol periods and/or cyclic prefix lengths. BWPs may have different bandwidths.

By configuring BWPs appropriately, the infrastructure equipment may provide BWPs which are suited for different types of services. For example, a BWP more suitable for eMBB may have a larger bandwidth in order to support high data rates. A BWP suited for URLLC services may use a higher sub-carrier spacing and shorter slot durations, in order to permit lower latency transmissions. Parameters of the wireless access interface which are applicable to a BWP may be referred to collectively as the numerology of a BWP. Examples of such parameters are sub-carrier spacing, symbol and slot durations and cyclic prefix length.

A BWP may comprise communications resources for uplink or downlink communications. For a communications device, an uplink (UL) BWP and a downlink (DL) BWP may be independently configured, and an association (e.g. pairing) of an UL BWP and a DL BWP may be configured. In some examples, uplink and downlink communications resources are separated in time, in which case time division duplexing (TDD) may be used. In case of TDD, a BWP-pair (UL BWP and DL BWP with the same bwp-id) may have the same centre frequency. In some examples uplink and downlink communications resources are separated in frequency, in which case frequency division duplexing (FDD) may be used. Where FDD is used, a UL BWP and a DL BWP may comprise two non-contiguous frequency ranges, one comprising communications resources for uplink communications and one comprising communications resources for downlink communications. In the remainder of the present disclosure, the term ‘bandwidth part’ (BWP) is used to refer to a pair of associated uplink and downlink bandwidth parts and as such, may comprise communications resources for both uplink and downlink transmissions. The terms ‘uplink bandwidth part’ and ‘downlink bandwidth part’ will be used where appropriate to refer to a bandwidth part comprising only, respectively, uplink communications resources and downlink communications resources.

An activated BWP refers to a BWP which may be used for the transmission or reception of data to or from the communications device 104, 260. An infrastructure equipment 101, 211, 212 may schedule transmissions to or by the communications device 104, 260 only on a BWP if that BWP is currently activated for the communications device 104, 260. On deactivated BWPs, the communications device 104, 260 may not monitor a PDCCH and may not transmit on PUCCH, PRACH and UL-SCH. Conventionally at most one BWP providing uplink communications resources and at most one BWP providing downlink communications resources may be activated at any given time in respect of a particular communications device.

In light of the differing parameters which may be applicable to BWPs, a single activated BWP may not be suitable for the transmission of data associated with different services, if those different services have different requirements (e.g. latency requirements) or characteristics (e.g. bandwidth/data rate). Prior to being activated, a BWP may be configured for use by the communications device 104, 260. That is, the communications device 104, 260 may determine the characteristics of the BWP, for example, by means of radio resource control (RRC) signalling transmitted by the infrastructure equipment 101.

A BWP may be designated as an initial downlink BWP, which provides the control resource set for downlink information used to schedule downlink transmissions of system information, and a corresponding initial uplink BWP for uplink transmissions for example for initiating PRACH transmission for initial access. A BWP may be designated as a primary BWP which is always activated and which may be used for transmitting control information to or by the communications device 104, 260. Since the primary BWP is always activated and thus may be used for data transmission, it may only be necessary to activate one or more further (secondary) BWPs if the primary BWP is unsuitable for an ongoing or new service or insufficient e.g. due to congestion or lack of bandwidth. Alternatively or additionally, a BWP may be designated as a default BWP. If no BWP is explicitly configured as a default BWP, a BWP which is designated as the initial BWP may be the default BWP.

A default BWP may be defined as a BWP that a UE falls back to after an inactivity timer, associated with a BWP other than the default BWP, expires. For example, where a non-default BWP is deactivated as a result of an associated inactivity timer expiring, and no other non-default BWP is activated, then a default BWP may be activated in response. A default BWP may have an activation or deactivation priority which differs from the activation or deactivation priority of other, non-default, BWPs. A default BWP may be preferentially activated and/or may be deactivated with lowest preference. For example, a default BWP may remain activated unless and until a further BWP is to be activated such that a maximum number of activated BWPs would be exceeded. A default BWP may further be preferentially used for transmitting an indication that a different BWP is to be activated or de-activated.

### Current RACH Procedures in LTE

In wireless telecommunications networks, such as LTE type networks, there are different Radio Resource Control (RRC) modes for terminal devices. For example, it is common to support an RRC idle mode (RRC_IDLE) and an RRC connected mode (RRC_CONNECTED). A terminal device in the idle mode may transition to connected mode, for example because it needs to transmit uplink data or respond to a paging request, by undertaking a random access procedure. The random access procedure involves the terminal device transmitting a preamble on a physical random access channel and so the procedure is commonly referred to as a RACH or PRACH procedure/process.

In addition to a terminal device deciding itself to initiate a random access procedure to connect to the network, it is also possible for the network, e.g. a base station, to instruct a terminal device in connected mode to initiate a random access procedure by transmitting to the terminal device an instruction to do so. Such an instruction is sometimes referred to as a PDCCH order (Physical Downlink Control Channel order); see, for example, Section 5.3.3.1.3 in ETSI TS 36.213 V13.0.0 (2016-01)/3GPP TS 36.212 version 13.0.0 Release 13 [3].

There are various scenarios in which a network triggered RACH procedure (PDCCH order) may arise. For example:
a terminal device may receive a PDCCH order to transmit on PRACH as part of a handover procedure;
a terminal device that is RRC connected to a base station but has not exchanged data with the base station for a relatively long time may receive a PDCCH order to cause the terminal device to transmit a PRACH preamble so that it can be re-synchronised to the network and allow the base station to correct timings for the terminal device;
a terminal device may receive a PDCCH order so that it can establish a different RRC configuration in the subsequent RACH procedure, this may apply, for example, for a narrowband IoT terminal device which is prevented from RRC reconfiguration in connected mode whereby sending the terminal device to idle mode through a PDCCH order allows the terminal device to be configured in the subsequent PRACH procedure, for example to configure the terminal device for a different coverage enhancement level (e.g. more or fewer repetitions).

For convenience, the term PDCCH order is used herein to refer to signalling transmitted by a base station to instruct a terminal device to initiate a PRACH procedure regardless of the cause. However, it will be appreciated such an instruction may in some cases be transmitted on other channels/in higher layers. For example, in respect of an intra-system handover procedure, what is referred to here as a PDCCH order may be an RRC Connection Reconfiguration instruction transmitted on a downlink shared channel/PDSCH.

When a PDCCH order is transmitted to a terminal device, the terminal device is assigned a PRACH preamble signature sequence to use for the subsequent PRACH procedure. This is different from a terminal device triggered PRACH procedure in which the terminal device selects a preamble from a predefined set and so could by coincidence select the same preamble as another terminal device performing a PRACH procedure at the same time, giving rise to potential contention. Consequently, for PRACH procedures initiated by a PDCCH order there is no contention with other terminal devices undertaking PRACH procedures at the same time because the PRACH preamble for the PDCCH ordered terminal device is scheduled by the network/base station.

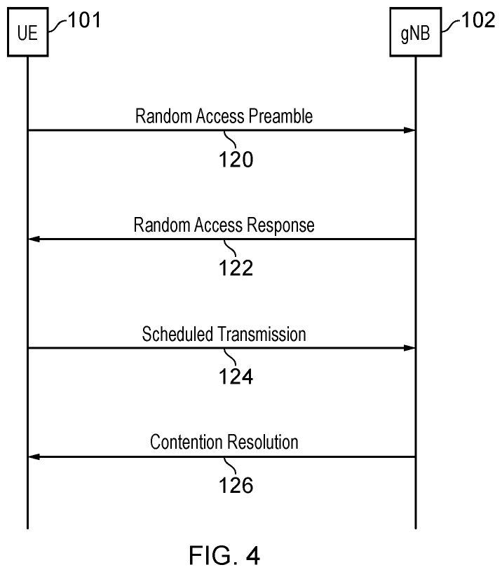

FIG. 4 shows a typical RACH procedure used in LTE systems such as that described by reference to FIG. 1 which could also be applied to an NR wireless communications system such as that described by reference to FIG. 2. A UE 101, which could be in an inactive or idle mode, may have some data which it needs to send to the network. To do so, it sends a random access preamble 120 to a gNodeB 102. This random access preamble 120 indicates the identity of the UE 101 to the gNodeB 102, such that the gNodeB 102 can address the UE 101 during later stages of the RACH procedure. Assuming the random access preamble 120 is successfully received by the gNodeB 102 (and if not, the UE 101 will simply re-transmit it with a higher power), the gNodeB 102 will transmit a random access response 122 message to the UE 101 based on the identity indicated in the received random access preamble 120. The random access response 122 message carries a further identity which is assigned by the gNodeB 102 to identify the UE 101, as well as a timing advance value (such that the UE 101 can change its timing to compensate for the round trip delay caused by its distance from the gNodeB 102) and grant uplink resources for the UE 101 to transmit the data in. Following the reception of the random access response message 122, the UE 101 transmits the scheduled transmission of data 124 to the gNodeB 102, using the identity assigned to it in the random access response message 122. Assuming there are no collisions with other UEs, which may occur if another UE and the UE 101 send the same random access preamble 120 to the gNodeB 102 at the same time and using the same frequency resources, the scheduled transmission of data 124 is successfully received by the gNodeB 102. The gNodeB 102 will respond to the scheduled transmission 124 with a contention resolution message 126.

How UE states (e.g. RRC_IDLE, RRC_CONNECTED etc.) may translate to NR systems has been recently discussed. For example, it has been agreed that a new “inactive” state should be introduced, where the UE should be able to start data transfer with a low delay (as necessitated by RAN requirements). The possibility of the UE being able to transmit data in the inactive state without transition to connected state has also been agreed. Two approaches have been identified as follows, in addition to a baseline move to the connected state before the transmission of data:
Data could be transmitted together with an initial RRC message requesting a transition to the connected state, or
Data could be transmitted in a new state.

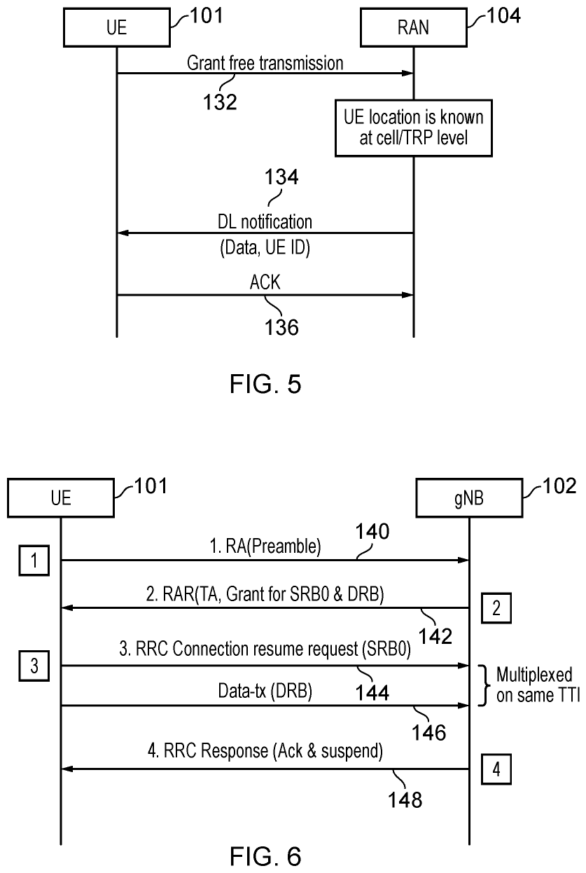

Discussions relating to uplink data transmission in the inactive state have sought solutions for sending uplink data without RRC signalling in the inactive state and without the UE initiating a transition to the connected state. A first potential solution is discussed in [4]. This solution is shown in FIG. 5, which is reproduced along with the accompanying text from [4]. As shown in FIG. 5, an uplink data transmission 132 can be made to a network 104 in the RRC_INACTIVE state by a UE 101. The network 104 here at least knows in which cell the transmission 132 was received, and potentially may even know via which TRP. For a certain amount of time after receiving an uplink data packet, the network 104 could assume that the UE 101 is still in the same location, so that any RLC acknowledgement or application response could be scheduled for transmission to the UE 101 in the same area where the UE 101 is, for example in the next paging response 134. Alternatively, the UE 101 may be paged in a wider area. Following reception of this downlink response 134 the UE 101 may transmit an acknowledgement 136 to the network 104 to indicate that it was successfully received.

A second potential solution is discussed in [5]. This solution is shown in FIG. 6, which is reproduced along with the accompanying text from [5]. The mechanism described in FIG. 6 is for small data transmissions and is based on the Suspend-Resume mechanism for LTE. The main difference is that User Plane data is transmitted simultaneously with message 3 (the RRC Connection resume request 144 in FIG. 6) and an optional RRC suspend signalled in message 4. As shown in FIG. 6, initially under the assumption of a random access scheme as in LTE, when a UE 101 receives uplink data to transmit to a gNodeB 102 of a mobile communications network, the UE 101 first transmits a random access (RA) preamble 140. Here a special set of preambles (a preamble partition) can be used as in LTE to indicate a small data transmission (meaning that the UE 101 wants a larger grant and possibly that the UE 101 wishes to remain in the inactive state).

The network (via the gNodeB 102) responds with a random access response (RAR) message 142 containing timing advance and a grant. The grant for message 3 should be large enough to fit both the RRC request and a small amount of data. The allowable size of the data could be specified and linked to the preambles, e.g. preamble X asks for a grant to allow Y bytes of data. Depending on available resources, the gNodeB 102 may supply a grant for message 3 accommodating only the resume request, in which case an additional grant could be supplied after reception of message 3.

At this point the UE 101 will prepare the RRC Connection Resume Request 144 and perform the following actions:
Re-establish Packet Data Convergence Protocol (PDCP) for SRBs and all DRBs that are established;
Re-establish RLC for signalling radio bearers (SRBs) and all data radio bearers (DRBs) that are established. The PDCP should reset sequence numbers (SN) and hyper frame numbers (HFN) during this step;
Resume SRBs and all DRBs that are suspended;
Derive a new security key (e.g. eNB key, or KeNB) possible based on next-hop chaining counters (NCC) provided before the UE 101 was sent to the “inactive” state;
Generate encryption and integrity protection keys and configure PDCP layers with previously configured security algorithm;
Generate RRC Connection Resume Request message 144;
An indication, e.g. a buffer status report (BSR), of potentially remaining data is added;
An indication that the UE 101 wishes to remain in the inactive state (if this is not indicated by the preamble) is added;
Apply the default physical channel and media access control (MAC) configuration; and
Submit RRC Connection Resume Request 144 and data 146 to lower layers for transmission.

After these steps, the lower layers transmit Message 3. This can also contain User Plane data 146 multiplexed by MAC, like existing LTE specifications as security context is already activated to encrypt the User Plane. The signalling (using SRB) and data (using DRB will be multiplexed by MAC layer (meaning the data is not sent on the SRB).

The network (via the gNodeB 102) receives Message 3 and uses the context identifier to retrieve the UE's 101 RRC context and re-establish the PDCP and RLC for the SRBs and DRBs. The RRC context contains the encryption key and the User Plane data is decrypted (will be mapped to the DRB that is re-established or to an always available contention based channel).

Upon successful reception of Message 3 and User Plane data, the network (via the gNodeB 102) responds with a new RRC response message 148 which could either be an “RRC suspend” or an “RRC resume” or an “RRC reject”. This transmission resolves contention and acts as an acknowledgement of Message 3. In addition to RRC signalling the network can in the same transmission acknowledge any user data (RLC acknowledgements). Multiplexing of RRC signalling and User Plane acknowledgements will be handled by the MAC layer. If the UE 101 loses the contention then a new attempt is needed.
In case the network decides to resume the UE 101, the message will be similar to a RRC resume and may include additional RRC parameters.
In case the network decides to immediately suspend the UE 101, the message will be similar to a RRC suspend. This message can possibly be delayed to allow downlink acknowledgements to be transmitted.
In case the network sends a resume reject the UE 101 will initiate a new scheduling request (SR) as in LTE, after some potential backoff time.

This procedure will, strictly speaking, transmit the User Plane data without the UE 101 fully entering RRC_CONNECTED, which formerly would happen when the UE 101 receives the RRC Response (Message 4) indicating resume. On the other hand, it uses the RRC context to enable encryption etc. even if the network's decision is to make the UE 101 remain in RRC_INACTIVE by immediately suspending the UE 101 again.

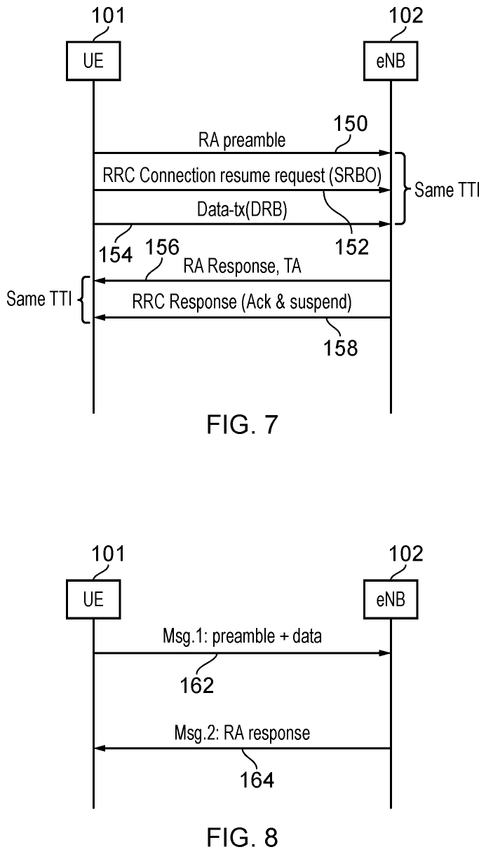

FIGS. 7 and 8 each show examples of a simplified two-step RACH procedure, in which small amounts of data can be transmitted by a UE 101 to an gNodeB or eNodeB 102. In the two-step RACH procedure, the data is transmitted at the same time as the RACH preamble (message 162 in FIG. 8), and so there is no need for the UE 101 to wait for a response from the network providing it with an uplink grant to transmit its data. However, the downside is that a limited amount of data can be transmitted in message 1. Following the reception of message 1 at the eNodeB 102, the eNodeB 101 transmits a random access response (message 162 in FIG. 8) to the UE 101, which comprises an acknowledgement of the received data in message 1. FIG. 7 shows the messages in a little more detail, where in message 1 (also termed herein msgA), the random access preamble 150, RRC connection resume request 152 and the small amount of data 154 are transmitted during the same transmission time interval (TTI). This message msgA is essentially a combination of Message 1 and Message 3 in the 4-step RACH procedure as shown for example in FIG. 6. Likewise, for message 2 (also termed herein msgB), the random access response with timing advance 156 and the RRC response 158 (comprising an acknowledgement and RRC suspend command) are transmitted by the eNodeB 102 to the UE 101 during the same TTI. This message msgB is essentially a combination of Message 2 and Message 4 in the 4-step RACH procedure as shown for example in FIG. 6. Further details relating to the two-step and four-step RACH procedures can be found in the 3GPP Technical Report 38.889 [6].

### 2-Step RACH in 5G Systems

Further enhancements to NR have already been started in Rel-16, such as that of the 2-step RACH as described above [7], Industrial Internet of Things (IIoT) [1] and NR-based Access to Unlicensed Spectrum [8]. In [7], the general MAC procedures covering both physical layer and higher layer aspects are specified. In general, the benefits of this are to reduce the time it takes for the connection setup/resume procedure to take place; for example, in the ideal situation the 2-step RACH will reduce the latency by halving the number of steps from 4 to 2 for initial access UEs. It has been concluded that a 2-step RACH procedure also has potential benefits for channel access in NR unlicensed spectrum (NR-U). In addition, the 2-step RACH procedure has been proposed to enable small data transmissions for UEs in RRC connected mode without UL synchronisation, as well as UEs in RRC_INACTIVE state.

In recent discussions of the 2-Step RACH procedure, RAN2 has decided that:
If a UE has a Cell-Radio Network Temporary Identifier (C-RNTI) before initiating the 2-Step RACH, the UE must include its C-RNTI in the payload of msgA, and then the UE shall monitor two RNTIs at the same time:
   for a response indicating a successful transmission of msgA, the UE should monitor a PDCCH addressed to the C-RNTI; and
   for a response indicating an unsuccessful transmission of msgA, the UE should monitor a PDCCH addressed to the msgB-RNTI (e.g. RA-RNTI or a new RNTI); and
If the PDCCH addressed to the C-RNTI (i.e. the C-RNTI was included in msgA) containing the 12 bit timing advance (TA) command or UL grant if the UE is synchronised already is received, the UE should consider the contention resolution to be successful and stop the reception of msgB.

In co-pending International Patent Application published under number WO 2018/127502 [9], the contents of which are hereby incorporated by reference, solutions were proposed to accommodate small data transmissions while exploiting the advantages given by the 2-step RACH design principle. In [9], for 2-Step RACH, the possibility for a UE to transmit data in an inactive state without transition to a connected state was proposed as follows:
UL data should be contained in both msgA and a further msgC. msgA contains the data that can only be accommodated in the reserved contention based resources, in addition to an indication to ask for additional uplink grant, while msgC contains any remaining UL data to transmit;
msgB response includes a C-RNTI and an additional uplink grant to be used for msgC.

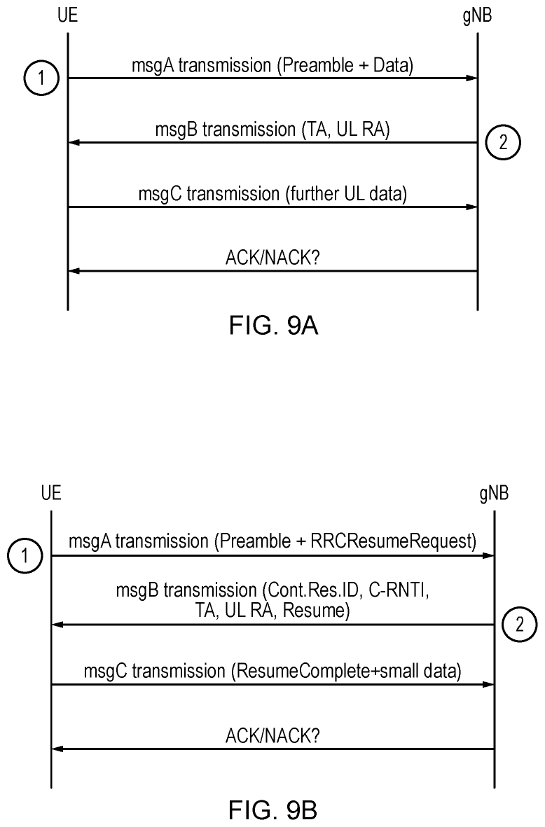

The case above where UE has a C-RNTI applies to the case captured in [9], as shown FIG. 9A. However, it has been recognised (and is indeed addressed by embodiments of the present technique as described herein) that if such a further msgC is supported, it needs to receive an acknowledgement (ACK/NACK) from the network as it will be the final message from the UE before it goes back to sleep.

In addition, it is possible that the data in msgA is an RRC message (e.g. RRCResumeRequest or RRCReestablishmentRequest). Hence, msgA's transport block size may not fit both the RRC message and the small amount of data in the 2 step RACH case. As shown FIG. 9B, in the case of the resume procedure, msgC must include an RRC resume complete message. So, again, if msgC includes one shot small data as well as the RRC resume complete message, then the problem described above with relation to FIG. 9A of needing an ACK/NACK still exists.

### ACK/NACK Feedback for UL Data Transmissions

LTE has an explicit ACK/NACK feedback for UL data transmissions, which is transmitted by the network using the Physical Hybrid-ARQ Indicator Channel (PHICH). Whenever a UE transmits UL data, the UE receives ACK or NACK feedback from the gNodeB for a given HARQ process, where if UE receives NACK it retransmits the same UL data on the same HARQ process. The PHICH carries a single bit (indicating either ACK or NACK) and the error rate is sufficiently low; typically ACK-to-NACK and NACK-to-ACK error rates in the order of 10\hat{ }-2 and 10\hat{ }-4 respectively, are targeted.

In NR, there is no explicit ACK/NACK feedback for UL data transmissions from UEs. However, the UE will adhere to the following procedures:
A UE keeps that UL data in its buffer until it receives a new data transmission from the gNB for the same HARQ process, meaning that the previous data transmission on this HARQ process was received correctly. In this case, the new data indicator bit (NDI) is toggled between 0 and 1 for successive data transmissions, or
If the UE receives a grant/PDCCH scheduling for retransmission on a given HARQ process and new data indicator (NDI) has not been toggled, the UE will retransmit the data in the buffer of the indicated HARQ process; and
Whenever a UE transmits UL data using a Configured Grant (CG), a timer (configuredGrantTimer) is started for the corresponding HARQ process, and the gNB can ask for retransmissions by PDCCH scheduling before the timer expires. If the timer expires, the UE assumes that the CG data was successfully received.

However, the overhead is an issue for the gNB to issue a grant/PDCCH each time it schedules retransmissions, especially when there are so many UEs in the cell. In addition to this, and as discussed earlier, an explicit ACK/NACK feedback may be necessary in some cases, such as small uplink data transmissions before a UE goes back to sleep or transitions to an inactive state for power saving—particularly important for MTC type UEs, for example.

Embodiments of the present technique seek to resolve the problem of lacking an acknowledgement (ACK/NACK) at least for the case of small uplink data transmissions in a 2-step RACH procedure. However, those skilled in the art would appreciate that solutions provided herein could also be applied to other features of NR.

### ACK/NACK Feedback Signalling For Small UL Data Transmissions for 5G Systems

Embodiments of the present technique provide signalling details of an explicit ACK/NACK feedback for small uplink data transmissions for all UEs in the cell.

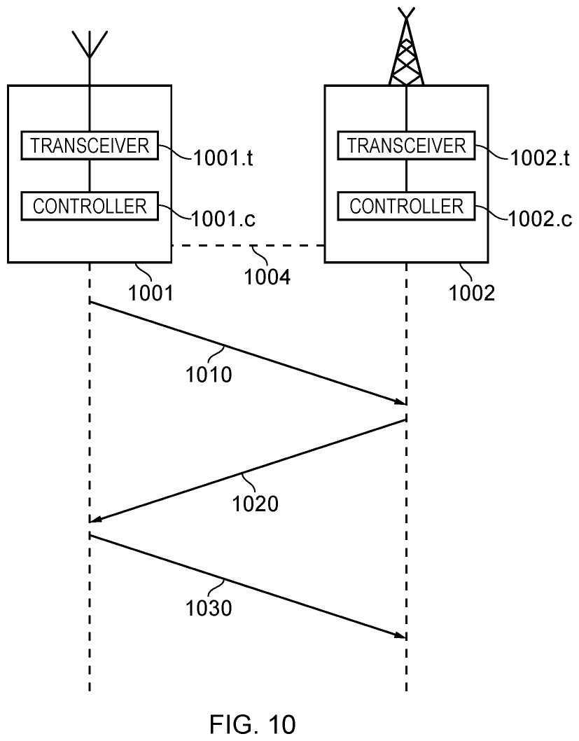

FIG. 10 provides a part schematic representation, part message flow diagram of communications between a communications device or UE 1001 and an infrastructure equipment or gNodeB 1002 of a wireless communications network in accordance with a first embodiment of the present technique. The infrastructure equipment 1002 provides a cell having a coverage area within which the communications device 1001 is located. The communications device 1001 comprises a transceiver (or transceiver circuitry) 1001.t configured to transmit signals to or receive signals from the infrastructure equipment 1002 via a wireless access interface 1004 provided by the wireless communications network, and a controller (or controller circuitry) 1001.c configured to control the transceiver circuitry 1001.t to transmit or to receive the signals. As can be seen in FIG. 10, the infrastructure equipment 1002 also comprises a transceiver (or transceiver circuitry) 1002.t configured to transmit signals to or receive signals from the communications device 1001 via the wireless access interface 1004, and a controller (or controller circuitry) 1002.c configured to control the transceiver circuitry 1002.t to transmit or to receive the signals. Each of the controllers 1001.c, 1002.c may be, for example, a microprocessor, a CPU, or a dedicated chipset, etc.

The controller circuitry 1001.c of the communications device 1001 is configured in combination with the transceiver circuitry 1001.t of the communications device 1001 to transmit 1010 a first signal comprising a random access preamble and a first portion of uplink data to the infrastructure equipment 1002, to receive 1020 a second signal comprising a random access response from the infrastructure equipment 1002 in response to the first signal 1010, and to transmit 1030, in response to receiving the second signal 1020, a third signal comprising a second portion of uplink data to the infrastructure equipment 1002, wherein the second signal 1020 further comprises an indication of downlink radio resources forming a Physical Downlink Shared Channel, PDSCH, reserved for the transmission of one or more acknowledgements or negative acknowledgements, ACK/NACKs, by the infrastructure equipment 1002, wherein one of the one or more ACK/NACKs from the infrastructure equipment 1002 is for reception by the communications device 1001 in response to the transmission of the third signal 1030.

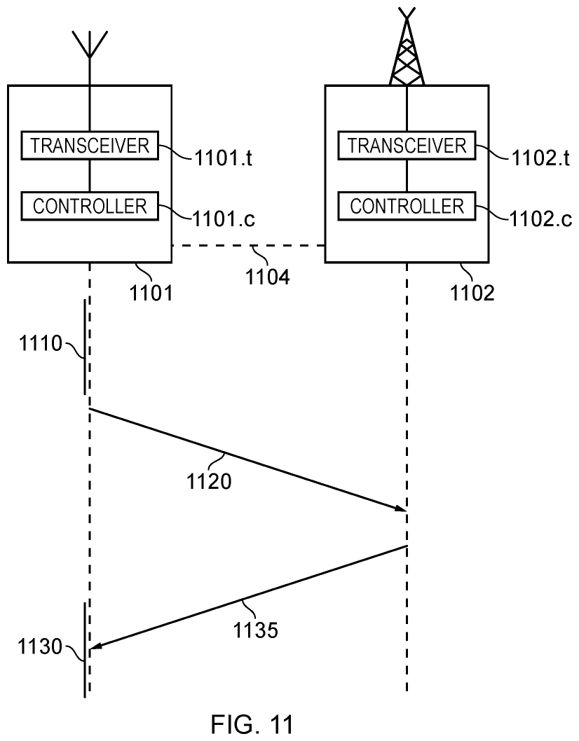

FIG. 11 provides a part schematic representation, part message flow diagram of communications between a communications device or UE 1101 and an infrastructure equipment or gNodeB 1102 of a wireless communications network in accordance with a first embodiment of the present technique. The infrastructure equipment 1102 provides a cell having a coverage area within which the communications device 1101 is located. The communications device 1101 comprises a transceiver (or transceiver circuitry) 1101.t configured to transmit signals to or receive signals from the infrastructure equipment 1102 via a wireless access interface 1104 provided by the wireless communications network, and a controller (or controller circuitry) 1101.c configured to control the transceiver circuitry 1101.t to transmit or to receive the signals. As can be seen in FIG. 11, the infrastructure equipment 1102 also comprises a transceiver (or transceiver circuitry) 1102.t configured to transmit signals to or receive signals from the communications device 1101 via the wireless access interface 1104, and a controller (or controller circuitry) 1102.c configured to control the transceiver circuitry 1102.t to transmit or to receive the signals. Each of the controllers 1101.c, 1102.c may be, for example, a microprocessor, a CPU, or a dedicated chipset, etc.

The controller circuitry 1101.c of the communications device 1101 is configured in combination with the transceiver circuitry 1101.t of the communications device 1101 to determine 1110 an acknowledgement identifier in accordance with predefined information known by both of the communications device 1101 and the infrastructure equipment 1102, to transmit 1120 a first signal comprising uplink data to the infrastructure equipment 1102, and to monitor 1130 for reception, from the infrastructure equipment 1102, of a Downlink Control Information, DCI, signal 1135 having the determined acknowledgement identifier 1110, wherein either: the DCI signal 1135 comprises an indication of downlink radio resources forming a Physical Downlink Shared Channel, PDSCH, reserved for the transmission of one or more acknowledgements or negative acknowledgements, ACK/NACKs, by the infrastructure equipment 1102, wherein one of the one or more ACK/NACKs from the infrastructure equipment 1102 is for reception by the communications device 1101 in response to the transmission of the first signal 1120; or the DCI signal 1135 comprises one or more ACK/NACKs, wherein one of the one or more ACK/NACKs is for reception by the communications device 1101 in response to the transmission of the first signal 1120.

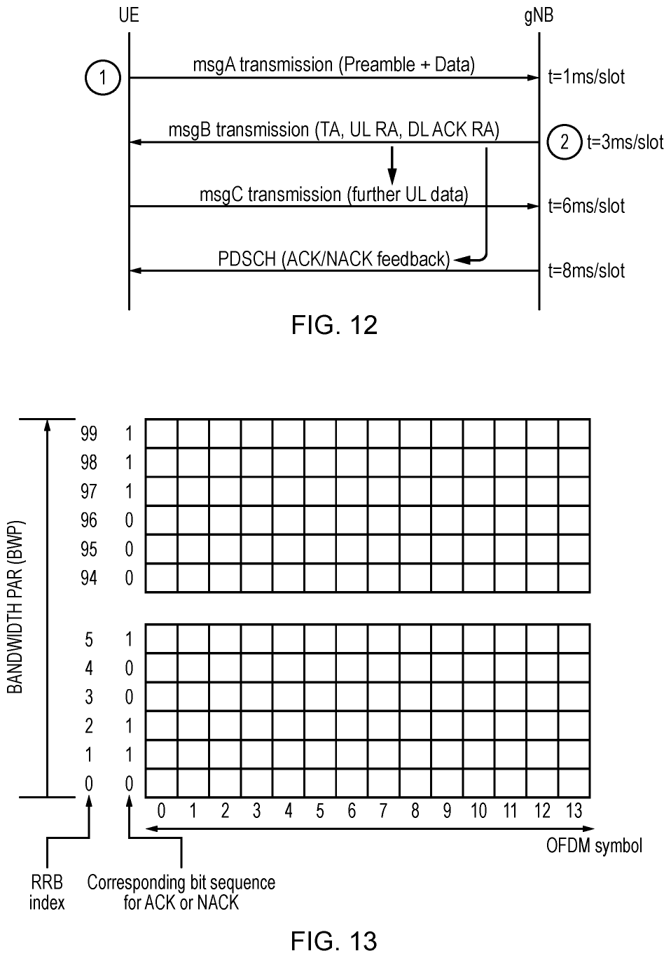

Essentially, in the first embodiment of the present technique, msgB of a 2-step RACH procedure contains an UL resource allocation (RA) for a small data transmission, and a DL RA for an ACK/NACK for this small data transmission. In this method, msgB may consist of a DCI addressed with a C-RNTI and a scheduled PDSCH intended for a single UE, where this PDSCH may contain small data transmission in the downlink in addition to other control information (e.g. UL RA, DL ACK RA). As shown in FIG. 12, msgB carries an UL RA for a further small data transmission (msgC) as well as a DL RA for a PDSCH carrying ACK feedback for one or more UEs. The RNTI (i.e. ACK-RNTI) used for the PDSCH carrying ACK feedback for one or more UEs can be determined in a number of different ways, which are described in detail below.

In addition, a time window may be specified in some arrangements of the first embodiment of the present technique for UE to look for this PDSCH after the UE has received msgB in the downlink, or after the UE has transmitted the small data in uplink (msgC). In other words, the indication of the downlink radio resources comprises an indication of a time window during which the communications device should monitor for the reception of the PDSCH. The start of the time window could be a fixed offset value or may dynamically indicated in msgB or may be RRC signalled from a higher layer to the UE. In other words, the indication of the time window comprises an indication of a starting time of the time window, wherein indication of the time window comprises an indication of a fixed time offset from one of a time of reception of the second signal and a time of transmission of the third signal, and the method comprises determining, based on the fixed offset time, a starting time of the time window. Alternatively, the communications device may be configured to receive via Radio Resource Control, RRC, signalling, an indication of a starting time of the time window. The length of the window should also be specified if it is longer than one slot. In other words, the indication of the time window comprises an indication of a temporal length of the time window. FIG. 12 shows an example of the order of messages in such a procedure; at time t=1 ms the gNB receives msgA, and at time t=3 ms the gNB sends a msgB response containing TA, UL RA and DL ACK RA to the UE. The gNB may also inform the UE about a future time window in msgB, and in this case the start time is fixed to 5 ms after the detection of the msgB response, and the length of the window is 1 ms. At time t=6 ms the gNB receives msgC (PUSCH), and the UE starts monitoring for the PDSCH, which carries ACK feedback, at time=8 ms.

Essentially, in the second embodiment of the present technique, a DCI may be transmitted by a gNodeB addressed with an ACK-RNTI and scheduling PUSCH resources for a small uplink data transmission.

This DCI and small uplink data transmission may be independent of a RACH procedure as described above in relation to the first embodiment of the present technique.

A main difference between this method and that of the first embodiment is that when a UE transmits the small data transmission in the uplink, it monitors a new DCI addressed with ACK-RNTI in the downlink (again, the ACK-RNTI used for the PDSCH carrying ACK feedback for one or more UEs can be determined in a number of different ways, which are described in detail below). In one arrangement, the DCI schedules resources for a PDSCH that contains ACK feedbacks for one or more UEs. In another arrangement, a UE monitors the DCI alone (i.e. there is no PDSCH scheduled) and it is this DCI that contains ACK feedback for one or more UEs. The following arrangements described in relation to the second embodiment of the present technique relate to both arrangements with a DCI scheduling a PUSCH and a DCI alone. As in the first embodiment of the present technique, the timing may also be defined for UE to look for a PDSCH or for the DCI (i.e. a future time window).

The PDSCH resource contains ACK feedback for one or more UEs. Hence in some arrangements, for the first embodiment, the communications device is configured to receive the PDSCH from the infrastructure equipment, determine whether one or more conditions associated with the PDSCH are satisfied, and if the one or more conditions are satisfied, to determine that the one of the one or more ACK/NACKs is for reception by the communications device in response to the transmission of the third signal. In these arrangements, for the second embodiment, the communications device is configured to receive the PDSCH or the DCI signal from the infrastructure equipment, to determine whether one or more conditions associated with the PDSCH or the DCI signal are satisfied, and if the one or more conditions are satisfied, to determine that the one of the one or more ACK/NACKs is for reception by the communications device in response to the transmission of the first signal. In other words, after a UE decodes the PDSCH addressed to a specific ACK-RNTI, the UE checks whether:
Its C-RNTI is included in the PDSCH (protocol data unit (PDU)). In this case, the PDSCH carries a list of C-RNTIs for different UEs. In other words, for the first embodiment the one or more conditions comprise the PDSCH comprising an identifier associated with the communications device. For the second embodiment, the one or more conditions comprise the PDSCH or the DCI signal comprising an identifier associated with the communications device;
The bits corresponding to physical resource block (PRB) indices used for UL small data transmission are turned on (1 means turned on for ACK, 0 means off for NACK). In this case, a DCI or PDSCH carries bit sequences corresponding to PRB indices in the BWP as shown in FIG. 13. In other words, for the first embodiment, the one or more conditions comprise each of one or more bits within the PDSCH associated with radio resources in which the communications device transmitted the third signal having a specified binary value (where this binary value may be either 0 or 1 depending on the configuration of the wireless communications system). For the second embodiment, the one or more conditions comprise each of one or more bits within the PDSCH or the DCI signal associated with radio resources in which the communications device transmitted the first signal having a specified binary value (where again this binary value may be either 0 or 1 depending on the configuration of the wireless communications system); and
   Its resource indicator value (RIV) used for the small UL data is included in the PDSCH (PDU). In this case, the PDSCH carries a list of RIVs for different UEs. In other words, for the first embodiment, the one or more conditions comprise the PDSCH comprising a Resource Indication Value, RIV, associated with the communications device. For the second embodiment, the one or more conditions comprise the PDSCH or the DCI signal comprising a Resource Indication Value, RIV, associated with the communications device.

For the second and third points above, relating to the bits corresponding to the PRB indices and to the RIVs, there are issues of using RIV or bit sequences in case of MU-MIMO where two or more UEs share same number of PRBs (i.e. multiplexed in code-domain), in that these UEs will have a similar RIV value or bit sequences and as consequence their ACK response cannot be differentiated. To solve this issue, in some arrangements of embodiments of the present technique, an additional piece of information can be included in the DCI or PDSCH, for example antenna port index can be different for UEs using in the same PRB resources. In this case, one DCI/PDSCH may contain ACK responses for PUSCH with antenna port 0, and another DCI/PDSCH for ACK responses for antenna port 1. Alternatively the sequences can be appended in the same DCI/PDSCH. In other words, for the first embodiment, when the communications device either transmits the third signal in the same radio resources used by another communications device, or has a similar RIV to another communications device, the one or more conditions further comprise determining whether the PDSCH comprises additional information associated with the communications device. The additional information may be an antenna port index associated with an antenna port used by the communications device to transmit the third signal. For the second embodiment, when the communications device either transmits the first signal in the same radio resources used by another communications device, or has a similar RIV to another communications device, the one or more conditions further comprise determining whether the PDSCH or the DCI signal comprises additional information associated with the communications device. The additional information may be an antenna port index associated with an antenna port used by the communications device to transmit the first signal.

If the above-described check is successful, the UE assumes an ACK for its most recent small uplink data transmission, otherwise UE assumes a NACK.

In another arrangement of at least the second embodiment of the present technique, the BWP may be partitioned into a number of equal-sized groups of PRBs, and the DCI itself (i.e. no PDSCH) may carry the ACK/NACK feedbacks corresponding to one of the groups. The DCI may contain a sequence of bits corresponding to the PRB indices within the group for the uplink BWP. In this case, the UE will only monitor the DCI corresponding to its group in which UE's starting (or ending) PRB index belongs, based on the BWP (again, the ACK-RNTI used for the PDSCH or DCI carrying ACK feedback for one or more UEs can be determined in a number of different ways, which are described in detail below). In other words, the DCI signal comprises an indication of an index of a group of physical resource blocks, and the communications device is configured to determine whether the group of physical resource blocks comprises a first or a last physical resource block of the radio resources in which the communications device transmitted the first signal, and if the group of physical resource blocks comprises the first or the last physical resource block of the radio resources in which the communications device transmitted the first signal, to monitor for the reception of the DCI signal.

In another embodiment of embodiments of the present technique, whether the UE monitors for the DCI or monitors for both the DCI and the PDSCH indicated by that DCI and addressed with the ACK-RNTI, is configurable from higher layers based on for example the service type or traffic characteristics (e.g. eMBB or URLLC). In addition, a UE at the cell edge may monitor DCI only, otherwise its overhead may be significant due to a low coding rate if the UE expects both the DCI and the PDSCH. In other words, the communications device is configured to monitor for the reception of the either of the DCI signal or the DCI signal and the PDSCH indicated by the DCI signal depending on one or more predetermined conditions.

In another arrangement of embodiments of the present technique, msgB (or a DCI) may contain information about the common CORESET (i.e. CORESET index) where UE monitors the DCI (scrambled by ACK-RNTI) that allocates the PDSCH carrying the ACK/NACKs for the UEs. Alternatively, the common CORESET for UEs to monitor for the DCI addressed with the ACK-RNTI can be broadcast in the System Information Blocks (SIB) or can be UE-specifically signalled. In other words, for the first embodiment, the communications device is configured to receive, from the infrastructure equipment, an indication of a set of radio resources forming a control-resource set, CORESET, that comprises the PDSCH, the CORESET either being specific to the communications device or common among a group of communications devices including the communications device. The indication of the CORESET may be included within the second signal. For the second embodiment, the communications device is configured to receive, from the infrastructure equipment, an indication of a set of radio resources forming a control-resource set, CORESET, in which the communications device should monitor for the DCI signal, the CORESET either being specific to the communications device or common among a group of communications devices including the communications device.

In another arrangement of the second embodiment of the present technique, a UE can be configured to monitor for a DCI with ACK-RNTI for HARQ acknowledgements when the UE is configured to be able to transmit signals utilising Configured Grant (CG) Type 1 and or Type 2. In other words, the communications device is configured to monitor for the reception of the DCI signal if the communications device has previously received, from the wireless communications network, an indication of a plurality of configured grants from the infrastructure equipment, each of the configured grants allocating a set of communications resources for the transmission of the data by the communications device (which may be within one of a plurality of bandwidth parts defining a frequency range within a system bandwidth of the cell).

### Determination of ACK-RNTI

For each of the first and second embodiments of the present technique, and in combination with any of the above described arrangements of these embodiments, the ACK-RNTI that is scrambled with DCI and or PDSCH needs to be determined based on some of the information that both the gNB and the UE know in advance (i.e. the predefined information as termed herein, which may comprise values of one or more parameters—a combination of these parameters is used as a basis for determining the ACK-RNTI). Arrangements of embodiments of the present technique envisage the four following options:

Option 1: The ACK-RNTI can be computed based on OFDM symbol, slot index and UL carrier type of the PUSCH resource as follows (similar to RA-RNTI):

ACK-RNTI=1+s_id+14×t_id+14×80×ul_carrier_id

where s_id is the index of the first OFDM symbol of the scheduled PUSCH resource (0≤s_id<14), t_id is the index of the slot in a system frame (0≤t_id<80), where the subcarrier spacing to determine t_id is based on the value of μ specified in subclause 4.3.2 of [10] (also shown in Table I below), and ul_carrier_id is the UL carrier used for PUSCH transmission (0 for NUL carrier, and 1 for SUL carrier).

TABLE I
Number of OFDM symbols per slot, slots per frame,
and slots per subframe for normal cyclic prefix

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

If a UE with a short PUSCH duration (e.g. 2 OFDM symbols) and another UE with a long PUSCH (e.g. 14 OFDM symbols) have the same starting OFDM symbol, they will monitor the same ACK-RNTI based on the above formula, and this would mean that the gNB has to delay the transmission of all ACK/NACK feedback until the UE with the long PUSCH duration completes its transmission. Hence, in order to avoid this delay, the last symbol of the PUSCH resource can be used instead (i.e. s_id is the index of the last OFDM symbol of the scheduled PUSCH resource (0≤s_id≤14)).

In other words, for Option 1, for the first embodiment, the communications device determines the acknowledgement identifier based on a combination of a plurality of parameters, the plurality of parameters comprising an index of a first or a last OFDM symbol of radio resources in which the communications device transmitted the third signal, an index of a time slot comprising the radio resources in which the communications device transmitted the third signal, and an index of an uplink carrier used for the transmission of the third signal. For Option 1, for the second embodiment, the communications device determines the acknowledgement identifier based on a combination of a plurality of parameters, the plurality of parameters comprising an index of a first or a last OFDM symbol of radio resources in which the communications device transmitted the first signal, an index of a time slot comprising the radio resources in which the communications device transmitted the first signal, and an index of an uplink carrier used for the transmission of the first signal.

Option 2: Enhanced ACK-RNTI based on Option 1: The concern for Option 1 is that the space required for signalling the RNTI will be significant. So in order to reduce the RNTI space, OFDM symbols can be grouped—for example a group of 2 OFDM symbols, because in the Rel-15 specification the minimum PUSCH allocation is 2 OFDM symbols. In addition, the number of slots can be reduced to 10 when the number of slots within a system frame is greater than 10 (see Table I). Based on this, the ACK-RNTI can be computed as follows:

ACK-RNTI=1+s_group_id+7×t_id+14×10×ul_carrier_id

where s_group_id is the OFDM symbol group index in which the first (or last) OFDM symbol of the scheduled PUSCH resource is located (0≤s_group_id<7), t_id is derived from the number of slots in a system frame, modulus 10 (i.e. Nₛₗₒₜ^{frame,μ}mod10) and the subcarrier spacing to determine t_id is based on the value of μ specified in subclause 4.3.2 of [10] (also shown in Table I above), and ul_carrier_id is the UL carrier used for PUSCH transmission (0 for NUL carrier, and 1 for SUL carrier).

In other words, for Option 2, for the first embodiment, the plurality of parameters comprises an index of a group of two or more OFDM symbols including the first or the last OFDM symbol of the radio resources in which the communications device transmitted the third signal. For Option 2, for the second embodiment, the plurality of parameters comprises an index of a group of two or more OFDM symbols including the first or the last OFDM symbol of the radio resources in which the communications device transmitted the first signal.

Option 3: Further Enhanced ACK-RNTI based on Option 2: The concern for Options 1 and 2 is that the content in the PDSCH/DCI addressed with ACK-RNTI will be too large (see the three bullet points discussed above in relation to a UE's checks after it decodes the PDSCH addressed to a specific ACK-RNTI). For example, if bit sequences are used, all bits corresponding to the whole BWP must be always included in the PDSCH/DCI (BWP size can be up to 275 PRBs). In order to reduce the content in the PDSCH/DCI, the active BWP can be partitioned into a number of equal-sized groups of PRBs, and the DCI itself carries the ACK/NACK feedback corresponding to one of the groups. The DCI contains a sequence of bits corresponding to the PRB indices within a group in the uplink BWP. The UE will only monitor a DCI corresponding to the group in which the UE's starting or ending PRB index belongs or a

DCI that the UE locates based on the BWP. Hence, an additional parameter from the group index can be added in the ACK-RNTI formula as follows:

ACK-RNTI=1+s_group_id+7×t_id+7×10×PRB_group_id+7×10×8×ul_carrier_id

where s_group_id is the OFDM symbol group index in which the first (or last) OFDM symbol of the scheduled PUSCH resource is located (0≤s_group_id<7), t_id is derived from the number of slots in a system frame, modulus 10 (i.e. Nₛₗₒₜ^{frame,μ}mod10) and the subcarrier spacing to determine t_id is based on the value of μ specified in subclause 4.3.2 of [10] (also shown in Table I above), PRB_group_id is the PRB group index in which the first (or last) PRB index of the scheduled PUSCH resource locates based on the current active BWP (0≤PRB_group_id<8), and ul_carrier_id is the UL carrier used for PUSCH transmission (0 for NUL carrier, and 1 for SUL carrier).

In other words, for Option 3, for the first embodiment, the plurality of parameters comprises an index of a group of physical resource blocks comprising a first or a last physical resource block of the radio resources in which the communications device transmitted the third signal. For Option 3, for the second embodiment, the plurality of parameters comprises an index of a group of physical resource blocks comprising a first or a last physical resource block of the radio resources in which the communications device transmitted the first signal.

Option 4: Even Further Enhanced ACK-RNTI based on Option 2: It is well-known that different UEs may experience different channel conditions, and as a result their CQI or aggregation levels (AL) for PDCCH (DCI) would be different. In practice, UEs at the cell edge need a higher aggregation level (e.g. 8 or 16) while UEs close to the gNB need a lower aggregation level (i.e. 2 or 4). Hence, if the above options are applied, it would mean that the gNB should always apply the highest aggregation level (e.g. 16) supported in NR as it does not have a mechanism to distinguish the channel conditions for different UEs. If both the gNB and the UE are aligned with the highest aggregation level that can be used for the DCI addressed with ACK-RNTI, then the UE should be able to monitor the DCI with a specific maximum aggregation level (i.e. single aggregation level). In addition, if UEs are distinguished with their aggregation levels, then this will also solve the issue of large content in the PDSCH/DCI addressed with ACK-RNTI (at least for the first and third bullet points discussed above in relation to a UE's checks after it decodes the PDSCH addressed to a specific ACK-RNTI) because the number of C-RNTI or RIVs included in one PDSCH are reduced. Hence, an additional parameter from the AL index can be added in the ACK-RNTI formula instead of PRB group index as follows:

ACK-RNTI=1+s_group_id+7×t_id+7×10×AL_group_id+7×10×4×ul_carrier_id

where s_group_id is the OFDM symbol group index in which the first (or last) OFDM symbol of the scheduled PUSCH resource is located (0≤s_group_id<7), t_id is derived from the number of slots in a system frame, modulus 10 (i.e. Nₛₗₒₜ^{frame,μ}mod10) and the subcarrier spacing to determine t_id is based on the value of μ specified in subclause 4.3.2 of [10] (also shown in Table I above), AL_id is the AL index (0≤AL_id<4) corresponding to four different aggregation levels of 2, 4, 8, 16, and ul_carrier_id is the UL carrier used for PUSCH transmission (0 for NUL carrier, and 1 for SUL carrier).

In other words, for Option 4, for the first embodiment, the plurality of parameters comprises an index of an aggregation level used by the communications device to monitor for reception of the PDSCH from the infrastructure equipment. For Option 4, for the second embodiment, the plurality of parameters comprises an index of an aggregation level used by the communications device to monitor for reception of the PDSCH or the DCI signal from the infrastructure equipment.

Regardless which of the above four options is specified, the ACK-RNTI should not be in the same space as the RA-RNTI space, and therefore an offset may be added to the formulas above. In addition, the introduction of an explicit HARQ-ACK feedback should not increase the maximum number of PDCCH blind decoding attempts. Hence, the DCI addressed to ACK-RNTI may not be the same size as one of the existing DCI formats in NR.

Alternatively to the above four options, in another arrangement of embodiments of the present technique, when there is a repetition or multiple consecutive transmission units of the same transport block from the UE, the determination of ACK-RNTI is based on or calculated from the first or last transmission unit (e.g. slot). In other words, if the communications device determines that it has transmitted as the third signal a plurality of consecutive transmission units of a same transport block, the communications device determines the acknowledgement identifier based on an index of a first or a last of the plurality of consecutive transmission units.

In a modification of the first embodiment, a timer is used instead of explicit HARQ-ACK feedback, where a UE starts a timer per HARQ process whenever there is an uplink data transmission of msgC of the 2-step RACH. If the timer expires, the UE assumes that the data was successfully received and can go to sleep. The gNB has a chance to ask for retransmission of the uplink data transmission by PDCCH scheduling before the timer expires. In other words, the communications device is configured to transmit a first signal comprising a random access preamble and a first portion of uplink data, to receive a second signal comprising a random access response in response to the first signal, to transmit, in response to receiving the second signal, a third signal comprising a second portion of uplink data, to start a timer upon transmission of the third signal, and to determine, if the third signal expires without the communications device receiving a retransmission request indicating that the communications device should retransmit the third signal, that the third signal has been successfully received. In addition, if the UE transmits the uplink data transmission repeatedly or transmits multiple consecutive units of the same transport block, the UE starts the timer after the last repetition or transmission unit (e.g. slot). In other words, if the communications device determines that it has transmitted as the third signal a plurality of consecutive transmission units of a same transport block or it has repeatedly transmitted the third signal a plurality of times, the communications device starts the timer upon transmission of a last of the plurality of consecutive transmission units or upon transmission of a last of the repeated transmissions of the third signal.

In a modification of the first embodiment, instead of using an explicit HARQ-ACK feedback or timer, a UE repeats the uplink data transmission of msgC of the 2-step RACH several times, and then the UE goes to sleep immediately (e.g. transitions into the RRC_INACTIVE state). The number of repetitions can be pre-configured by the network via for example in the SIBs, or can be configured by UE specific RRC signalling. In other words, the communications device is configured to transmit a first signal comprising a random access preamble and a first portion of uplink data, to receive a second signal comprising a random access response in response to the first signal, to transmit, in response to receiving the second signal, a third signal comprising a second portion of uplink data, wherein the communications device repeatedly transmits the third signal a plurality of times, and to transition into an inactive state.

In some arrangements of the first embodiment, the third signal is the final UL signal or message before the UE goes to sleep (e.g. transitions into the RRC_INACTIVE state)—after it has received an ACK from the network for the third signal, or a timer initiated after transmitting the third signal has expired, or after a required number of repeated transmissions of the third signal has been carried out, etc. In other words, the third signal is a final signal transmitted by the communications device before the communications device transitions into an inactive state. There may be one or more intermediate UL messages communicated between the UE and network between the second signal (i.e. msgB) and the third signal, and hence while the third signal as termed herein is thus the final signal in the message exchange, it may not actually be the third signal of the message exchange.

### Flow Diagram Representation

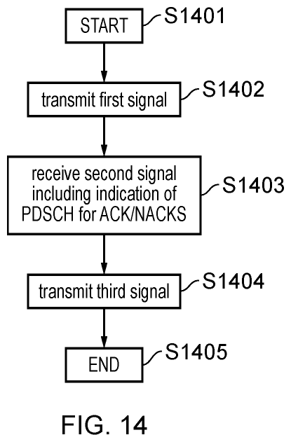

FIG. 14 shows a first flow diagram illustrating a method for transmitting data or receiving data by a communications device to or from an infrastructure equipment in a cell of a wireless communications network in accordance with the first embodiment of the present technique. The method begins in step S1401. The method comprises, in step S1402, transmitting a first signal comprising a random access preamble and a first portion of uplink data to the infrastructure equipment. The method then comprises in step S1403, receiving a second signal comprising a random access response from the infrastructure equipment in response to the first signal. In step S1404, the process comprises transmitting, in response to receiving the second signal, a third signal comprising a second portion of uplink data to the infrastructure equipment. The second signal further comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for reception by the communications device in response to the transmission of the third signal. The process ends in step S1405.

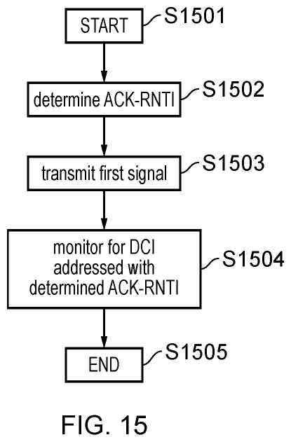

FIG. 15 shows a second flow diagram illustrating a method for transmitting data or receiving data by a communications device to or from an infrastructure equipment in a cell of a wireless communications network in accordance with the second embodiment of the present technique. The method begins in step S1501. The method comprises, in step S1502, determining an acknowledgement identifier in accordance with predefined information known by both of the communications device and the infrastructure equipment. The method then comprises in step S1503, transmitting a first signal comprising uplink data to the infrastructure equipment. In step S1504, the process comprises monitoring for reception, from the infrastructure equipment, of a Downlink Control Information, DCI, signal having the determined acknowledgement identifier. Either: the DCI signal comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for reception by the communications device in response to the transmission of the first signal; or the DCI signal comprises one or more ACK/NACKs, wherein one of the one or more ACK/NACKs is for reception by the communications device in response to the transmission of the first signal. The process ends in step S1505.

Those skilled in the art would appreciate that the methods shown by FIGS. 14 and 15 may be adapted in accordance with embodiments of the present technique. For example, other intermediate steps may be included in the methods, or the steps may be performed in any logical order.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method for transmitting data or receiving data by a communications device, the method comprising
transmitting a first signal comprising a random access preamble and a first portion of uplink data,
receiving a second signal comprising a random access response in response to the first signal, and
transmitting, in response to receiving the second signal, a third signal comprising a second portion of uplink data,
wherein the second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the third signal.

Paragraph 2. A method according to Paragraph 1, wherein the indication of the downlink radio resources comprises an indication of a time window during which the communications device should monitor for the reception of the PDSCH.

Paragraph 3. A method according to Paragraph 2, wherein the indication of the time window comprises an indication of a starting time of the time window.

Paragraph 4. A method according to Paragraph 2 or Paragraph 3, wherein indication of the time window comprises an indication of a fixed time offset from one of a time of reception of the second signal and a time of transmission of the third signal, and the method comprises determining, based on the fixed offset time, a starting time of the time window.

Paragraph 5. A method according to any of Paragraphs 2 to 4, wherein the indication of the time window comprises an indication of a temporal length of the time window.

Paragraph 6. A method according to any of Paragraphs 2 to 5, comprising receiving, via Radio Resource Control, RRC, signalling, an indication of a starting time of the time window.

Paragraph 7. A method according to any of Paragraphs 1 to 6, comprising
receiving the PDSCH,
determining whether one or more conditions associated with the PDSCH are satisfied, and
if the one or more conditions are satisfied, determining that the one of the one or more ACK/NACKs is for reception by the communications device in response to the transmission of the third signal.

Paragraph 8. A method according to Paragraph 7, wherein the one or more conditions comprise the PDSCH comprising an identifier associated with the communications device.

Paragraph 9. A method according to Paragraph 7 or Paragraph 8, wherein the one or more conditions comprise each of one or more bits within the PDSCH associated with radio resources in which the communications device transmitted the third signal having a specified binary value.

Paragraph 10. A method according to any of Paragraphs 7 to 9, wherein the one or more conditions comprise the PDSCH comprising a Resource Indication Value, RIV, associated with the communications device.

Paragraph 11. A method according to Paragraph 9 or Paragraph 10, wherein when the communications device either transmits the third signal in the same radio resources used by another communications device, or has a similar RIV to another communications device, the one or more conditions further comprise determining whether the PDSCH comprises additional information associated with the communications device.

Paragraph 12. A method according to Paragraph 11, wherein the additional information is an antenna port index associated with an antenna port used by the communications device to transmit the third signal.

Paragraph 13. A method according to any of Paragraphs 1 to 12, comprising receiving, an indication of a set of radio resources forming a control-resource set, CORESET, that comprises the PDSCH, the CORESET either being specific to the communications device or common among a group of communications devices including the communications device.

Paragraph 14. A method according to Paragraph 13, wherein the indication of the CORESET is included within the second signal.

Paragraph 15. A method according to any of Paragraphs 1 to 14, comprising
determining an acknowledgement identifier in accordance with predefined information known by the communications device,
receiving the PDSCH,
determining whether the PDSCH comprises the determined acknowledgement identifier, and
if the PDSCH comprises the determined acknowledgement identifier, determining that the one of the one or more ACK/NACKs is for reception by the communications device in response to the transmission of the third signal.

Paragraph 16. A method according to Paragraph 15, wherein the communications device determines the acknowledgement identifier based on a combination of a plurality of parameters, the plurality of parameters comprising an index of a first or a last OFDM symbol of radio resources in which the communications device transmitted the third signal, an index of a time slot comprising the radio resources in which the communications device transmitted the third signal, and an index of an uplink carrier used for the transmission of the third signal.

Paragraph 17. A method according to Paragraph 16, wherein the plurality of parameters comprises an index of a group of two or more OFDM symbols including the first or the last OFDM symbol of the radio resources in which the communications device transmitted the third signal.

Paragraph 18. A method according to Paragraph 17, wherein the plurality of parameters comprises an index of a group of physical resource blocks comprising a first or a last physical resource block of the radio resources in which the communications device transmitted the third signal.

Paragraph 19. A method according to Paragraph 17 or Paragraph 18, wherein the plurality of parameters comprises an index of an aggregation level used by the communications device to monitor for reception of the PDSCH.

Paragraph 20. A method according to any of Paragraphs 15 to 19, wherein, if the communications device determines that it has transmitted as the third signal a plurality of consecutive transmission units of a same transport block, the communications device determines the acknowledgement identifier based on an index of a first or a last of the plurality of consecutive transmission units.

Paragraph 21. A method according to any of Paragraphs 1 to 20, wherein the third signal is a final signal transmitted by the communications device before the communications device transitions into an inactive state.

Paragraph 22. A method for transmitting data or receiving data by a communications device, the method comprising
determining an acknowledgement identifier in accordance with predefined information known by the communications device,
transmitting a first signal comprising uplink data, and
monitoring for reception of a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the first signal; or the DCI signal comprises one or more ACK/NACKs, wherein one of the one or more ACK/NACKs is for reception by the communications device in response to the transmission of the first signal.

Paragraph 23. A method according to Paragraph 22, comprising
receiving the PDSCH or the DCI signal,
determining whether one or more conditions associated with the PDSCH or the DCI signal are satisfied, and
if the one or more conditions are satisfied, determining that the one of the one or more ACK/NACKs is for reception by the communications device in response to the transmission of the first signal.

Paragraph 24. A method according to Paragraph 23, wherein the one or more conditions comprise the PDSCH or the DCI signal comprising an identifier associated with the communications device.

Paragraph 25. A method according to Paragraph 23 or Paragraph 24, wherein the one or more conditions comprise each of one or more bits within the PDSCH or the DCI signal associated with radio resources in which the communications device transmitted the first signal having a specified binary value.

Paragraph 26. A method according to Paragraph 25, wherein the one or more conditions comprise the PDSCH or the DCI signal comprising a Resource Indication Value, RIV, associated with the communications device.

Paragraph 27. A method according to Paragraph 25 or Paragraph 26, wherein when the communications device either transmits the first signal in the same radio resources used by another communications device, or has a similar RIV to another communications device, the one or more conditions further comprise determining whether the PDSCH or the DCI signal comprises additional information associated with the communications device.

Paragraph 28. A method according to Paragraph 27, wherein the additional information is an antenna port index associated with an antenna port used by the communications device to transmit the first signal.

Paragraph 29. A method according to any of Paragraphs 22 to 38, wherein the DCI signal comprises an indication of an index of a group of physical resource blocks, and the method comprises
determining whether the group of physical resource blocks comprises a first or a last physical resource block of the radio resources in which the communications device transmitted the first signal, and
if the group of physical resource blocks comprises the first or the last physical resource block of the radio resources in which the communications device transmitted the first signal, monitoring for the reception of the DCI signal.

Paragraph 30. A method according to any of Paragraphs 22 to 29, comprising monitoring for the reception of the either of the DCI signal or the DCI signal and the PDSCH indicated by the DCI signal depending on one or more predetermined conditions.

Paragraph 31. A method according to any of Paragraphs 22 to 30, comprising receiving an indication of a set of radio resources forming a control-resource set, CORESET, in which the communications device should monitor for the DCI signal, the CORESET either being specific to the communications device or common among a group of communications devices including the communications device.

Paragraph 32. A method according to any of Paragraphs 22 to 31, comprising monitoring for the reception of the DCI signal if the communications device has previously received an indication of a plurality of configured grants, each of the configured grants allocating a set of communications resources for the transmission of the data by the communications device.

Paragraph 33. A method according to any of Paragraphs 22 to 32, wherein the communications device determines the acknowledgement identifier based on a combination of a plurality of parameters, the plurality of parameters comprising an index of a first or a last OFDM symbol of radio resources in which the communications device transmitted the first signal, an index of a time slot comprising the radio resources in which the communications device transmitted the first signal, and an index of an uplink carrier used for the transmission of the first signal.

Paragraph 34. A method according to Paragraph 33, wherein the plurality of parameters comprises an index of a group of two or more OFDM symbols including the first or the last OFDM symbol of the radio resources in which the communications device transmitted the first signal.

Paragraph 35. A method according to Paragraph 34, wherein the plurality of parameters comprises an index of a group of physical resource blocks comprising a first or a last physical resource block of the radio resources in which the communications device transmitted the first signal.

Paragraph 36. A method according to Paragraph 34 or Paragraph 35, wherein the plurality of parameters comprises an index of an aggregation level used by the communications device to monitor for reception of the PDSCH or the DCI signal.

Paragraph 37. A method according to any of Paragraphs 22 to 36, wherein, if the communications device determines that it has transmitted as the first signal a plurality of consecutive transmission units of a same transport block, the communications device determines the acknowledgement identifier based on an index of a first or a last of the plurality of consecutive transmission units.

Paragraph 38. A communications device configured to transmit data or receive data, the communications device comprising
transceiver circuitry configured to transmit signals and receive signals via a wireless access interface, and
controller circuitry configured in combination with the transceiver circuitry
to transmit a first signal comprising a random access preamble and a first portion of uplink data,
to receive a second signal comprising a random access response in response to the first signal, and
to transmit, in response to receiving the second signal, a third signal comprising a second portion of uplink data,
wherein the second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the third signal.

Paragraph 39. Circuitry for a communications device configured to transmit data or receive data, the communications device comprising
transceiver circuitry configured to transmit signals and receive signals via a wireless access interface, and
controller circuitry configured in combination with the transceiver circuitry
to transmit a first signal comprising a random access preamble and a first portion of uplink data,
to receive a second signal comprising a random access response in response to the first signal, and
to transmit, in response to receiving the second signal, a third signal comprising a second portion of uplink data,
wherein the second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the third signal.

Paragraph 40. A method for transmitting data or receiving data by an infrastructure equipment in a cell of a wireless communications network, the method comprising
receiving a first signal comprising a random access preamble and a first portion of uplink data,
transmitting, in response to receiving the first signal, a second signal comprising a random access response, and
receiving a third signal comprising a second portion of uplink data in response to the second signal,
wherein the second signal further comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for transmission in response to the reception of the third signal.

Paragraph 41. An infrastructure equipment in a cell of a wireless communications network configured to transmit data or receive data in a cell of a wireless communications network, the infrastructure equipment comprising
transceiver circuitry configured to transmit signals and receive signals via a wireless access interface provided by the wireless communications network, and
controller circuitry configured in combination with the transceiver circuitry
to receive a first signal comprising a random access preamble and a first portion of uplink data,
to transmit, in response to receiving the first signal, a second signal comprising a random access response, and
to receive a third signal comprising a second portion of uplink data in response to the second signal,
wherein the second signal further comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for transmission in response to the reception of the third signal.

Paragraph 42. Circuitry for an infrastructure equipment in a cell of a wireless communications network configured to transmit data or receive data in a cell of a wireless communications network, the infrastructure equipment comprising
transceiver circuitry configured to transmit signals and receive signals via a wireless access interface provided by the wireless communications network, and
controller circuitry configured in combination with the transceiver circuitry
to receive a first signal comprising a random access preamble and a first portion of uplink data,
to transmit, in response to receiving the first signal, a second signal comprising a random access response, and
to receive a third signal comprising a second portion of uplink data in response to the second signal,
wherein the second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for transmission in response to the reception of the third signal.

Paragraph 43. A communications device configured to transmit data or receive data, the communications device comprising
transceiver circuitry configured to transmit signals and receive signals via a wireless access interface, and
controller circuitry configured in combination with the transceiver circuitry
to determine an acknowledgement identifier in accordance with predefined information known by the communications device,
to transmit a first signal comprising uplink data, and
to monitor for reception of a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the first signal; or the DCI signal comprises one or more ACK/NACKs, wherein one of the one or more ACK/NACKs is for reception by the communications device in response to the transmission of the first signal.

Paragraph 44. Circuitry for a communications device configured to transmit data or receive data, the communications device comprising
transceiver circuitry configured to transmit signals and receive signals via a wireless access interface, and
controller circuitry configured in combination with the transceiver circuitry
to determine an acknowledgement identifier in accordance with predefined information known by the communications device,
to transmit a first signal comprising uplink data, and
to monitor for reception of a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the first signal; or the DCI signal comprises one or more ACK/NACKs, wherein one of the one or more ACK/NACKs is for reception by the communications device in response to the transmission of the first signal.

Paragraph 45. A method for transmitting data or receiving data by an infrastructure equipment in a cell of a wireless communications network, the method comprising
determining an acknowledgement identifier in accordance with predefined information known by the infrastructure equipment,
receiving a first signal comprising uplink data, and
transmitting, in response to receiving the first signal, a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for transmission in response to the reception of the first signal; or the DCI signal comprises one or more ACK/NACKs, wherein one of the one or more ACK/NACKs is for transmission in response to the reception of the first signal.

Paragraph 46. An infrastructure equipment in a cell of a wireless communications network configured to transmit data or receive data in a cell of a wireless communications network, the infrastructure equipment comprising
transceiver circuitry configured to transmit signals and receive signals via a wireless access interface provided by the wireless communications network, and
controller circuitry configured in combination with the transceiver circuitry
to determine an acknowledgement identifier in accordance with predefined information known by the infrastructure equipment,
to receive a first signal comprising uplink data, and
to transmit, in response to receiving the first signal, a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for transmission in response to the reception of the first signal; or the DCI signal comprises one or more ACK/NACKs, wherein one of the one or more ACK/NACKs is for transmission in response to the reception of the first signal.

Paragraph 47. Circuitry for an infrastructure equipment in a cell of a wireless communications network configured to transmit data or receive data in a cell of a wireless communications network, the infrastructure equipment comprising
transceiver circuitry configured to transmit signals and receive signals via a wireless access interface provided by the wireless communications network, and
controller circuitry configured in combination with the transceiver circuitry
to determine an acknowledgement identifier in accordance with predefined information known by the infrastructure equipment,
to receive a first signal comprising uplink data, and
to transmit, in response to receiving the first signal, a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for transmission in response to the reception of the first signal; or the DCI signal comprises one or more ACK/NACKs, wherein one of the one or more ACK/NACKs is for transmission in response to the reception of the first signal.

Paragraph 48. A method for transmitting data or receiving data by a communications device, the method comprising
transmitting a first signal comprising a random access preamble and a first portion of uplink data,
receiving a second signal comprising a random access response in response to the first signal,
transmitting, in response to receiving the second signal, a third signal comprising a second portion of uplink data,
starting a timer upon transmission of the third signal, and
determining, if the third signal expires without the communications device receiving a retransmission request indicating that the communications device should retransmit the third signal, that the third signal has been successfully received.

Paragraph 49. A method according to Paragraph 48, wherein, if the communications device determines that it has transmitted as the third signal a plurality of consecutive transmission units of a same transport block or it has repeatedly transmitted the third signal a plurality of times, the communications device starts the timer upon transmission of a last of the plurality of consecutive transmission units or upon transmission of a last of the repeated transmissions of the third signal.

Paragraph 50. A method according to Paragraph 48 or Paragraph 49, wherein the third signal is a final signal transmitted by the communications device before the communications device transitions into an inactive state.

Paragraph 51. A communications device configured to transmit data or receive data, the communications device comprising
transceiver circuitry configured to transmit signals and receive signals via a wireless access interface, and
controller circuitry configured in combination with the transceiver circuitry
to transmit a first signal comprising a random access preamble and a first portion of uplink data,
to receive a second signal comprising a random access response in response to the first signal,
to transmit, in response to receiving the second signal, a third signal comprising a second portion of uplink data,
to start a timer upon transmission of the third signal, and
to determine, if the third signal expires without the communications device receiving a retransmission request indicating that the communications device should retransmit the third signal, that the third signal has been successfully received.

Paragraph 52. Circuitry for a communications device configured to transmit data or receive data, the communications device comprising
transceiver circuitry configured to transmit signals and receive signals via a wireless access interface, and
controller circuitry configured in combination with the transceiver circuitry
to transmit a first signal comprising a random access preamble and a first portion of uplink data,
to receive a second signal comprising a random access response in response to the first signal,
to transmit, in response to receiving the second signal, a third signal comprising a second portion of uplink data,
to start a timer upon transmission of the third signal, and
to determine, if the third signal expires without the communications device receiving a retransmission request indicating that the communications device should retransmit the third signal, that the third signal has been successfully received.

Paragraph 53. A method for transmitting data or receiving data by a communications device, the method comprising
transmitting a first signal comprising a random access preamble and a first portion of uplink data,
receiving a second signal comprising a random access response in response to the first signal,
transmitting, in response to receiving the second signal, a third signal comprising a second portion of uplink data, wherein the communications device repeatedly transmits the third signal a plurality of times, and
transitioning into an inactive state.

Paragraph 54. A method according to Paragraph 53, wherein the third signal is a final signal transmitted by the communications device before the communications device transitions into the inactive state.

Paragraph 55. A communications device configured to transmit data or receive data, the communications device comprising
transceiver circuitry configured to transmit signals and receive signals via a wireless access interface, and
controller circuitry configured in combination with the transceiver circuitry
to transmit a first signal comprising a random access preamble and a first portion of uplink data,
to receive a second signal comprising a random access response in response to the first signal,
to transmit, in response to receiving the second signal, a third signal comprising a second portion of uplink data, wherein the communications device repeatedly transmits the third signal a plurality of times, and
to transition into an inactive state.

Paragraph 56. Circuitry for a communications device configured to transmit data or receive data, the communications device comprising
transceiver circuitry configured to transmit signals and receive signals via a wireless access interface, and
controller circuitry configured in combination with the transceiver circuitry
to transmit a first signal comprising a random access preamble and a first portion of uplink data,
to receive a second signal comprising a random access response in response to the first signal,
to transmit, in response to receiving the second signal, a third signal comprising a second portion of uplink data, wherein the communications device repeatedly transmits the third signal a plurality of times, and
to transition into an inactive state.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] RP-182090, “Revised SID: Study on NR Industrial Internet of Things (IoT),” 3GPP RAN #81.

[2] Holma H. and Toskala A, “LTE for UMTS OFDMA and SC-FDMA based radio access”, John Wiley and Sons, 2009.

[3] ETSI TS 136 213 V13.0.0 (2016-01)/3GPP TS 36.212 version 13.0.0 Release 13.

[4] R2-168544, “UL data transmission in RRC_INACTIVE,” Huawei, HiSilicon, RAN #96.

[5] R2-168713, “Baseline solution for small data transmission in RRC_INACTIVE,” Ericsson, Ran #96.

[6] TR 38.889, V16.0.0, “3^{rd} Generation Partnership Project; Technical Specification Group Radio Access Network; Study on NR-based Access to Unlicensed Spectrum; (Release 16),” 3GPP, December 2018.

[7] RP-182894, “New WID: 2-step RACH for NR,” ZTE, RAN #82.

[8] RP-182878, “NR-based Access to Unlicensed Spectrum,” Qualcomm, RAN #82.

[9] International Patent Application Publication No. WO 2018/127502.

[10] TS 38.211, V15.4.0, “NR; Physical channels and modulation (Release 15),” 3GPP, January 2019.

1. A method for transmitting data or receiving data by a communications device, the method comprising
transmitting a first signal comprising a random access preamble and a first portion of uplink data,
receiving a second signal comprising a random access response in response to the first signal, and
transmitting, in response to receiving the second signal, a third signal comprising a second portion of uplink data,
wherein the second signal further comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the third signal.

2. A method according to claim 1, wherein the indication of the downlink radio resources comprises an indication of a time window during which the communications device should monitor for the reception of the PDSCH.

3. A method according to claim 2, wherein the indication of the time window comprises an indication of a starting time of the time window.

4. A method according to claim 2, wherein indication of the time window comprises an indication of a fixed time offset from one of a time of reception of the second signal and a time of transmission of the third signal, and the method comprises determining, based on the fixed offset time, a starting time of the time window.

5. A method according to claim 2, wherein the indication of the time window comprises an indication of a temporal length of the time window.

6. A method according to claim 2, comprising receiving, via Radio Resource Control, RRC, signalling, an indication of a starting time of the time window.

7. A method according to claim 1, comprising
receiving the PDSCH,
determining whether one or more conditions associated with the PDSCH are satisfied, and
if the one or more conditions are satisfied, determining that the one of the one or more ACK/NACKs is for reception by the communications device in response to the transmission of the third signal.

8. A method according to claim 7, wherein the one or more conditions comprise the PDSCH comprising an identifier associated with the communications device.

9. A method according to claim 7, wherein the one or more conditions comprise each of one or more bits within the PDSCH associated with radio resources in which the communications device transmitted the third signal having a specified binary value.

10. A method according to claim 7, wherein the one or more conditions comprise the PDSCH comprising a Resource Indication Value, RIV, associated with the communications device.

11. A method according to claim 9 or claim 10, wherein when the communications device either transmits the third signal in the same radio resources used by another communications device, or has a similar RIV to another communications device, the one or more conditions further comprise determining whether the PDSCH comprises additional information associated with the communications device.

12. A method according to claim 11, wherein the additional information is an antenna port index associated with an antenna port used by the communications device to transmit the third signal.

13. A method according to claim 1, comprising receiving, an indication of a set of radio resources forming a control-resource set, CORESET, that comprises the PDSCH, the CORESET either being specific to the communications device or common among a group of communications devices including the communications device.

14. A method according to claim 13, wherein the indication of the CORESET is included within the second signal.

15. A method according to claim 1, comprising
determining an acknowledgement identifier in accordance with predefined information known by the communications device,
receiving the PDSCH,
determining whether the PDSCH comprises the determined acknowledgement identifier, and
if the PDSCH comprises the determined acknowledgement identifier, determining that the one of the one or more ACK/NACKs is for reception by the communications device in response to the transmission of the third signal.

16. A method according to claim 15, wherein the communications device determines the acknowledgement identifier based on a combination of a plurality of parameters, the plurality of parameters comprising an index of a first or a last OFDM symbol of radio resources in which the communications device transmitted the third signal, an index of a time slot comprising the radio resources in which the communications device transmitted the third signal, and an index of an uplink carrier used for the transmission of the third signal.

17.-19. (canceled)

20. A method according to claim 15, wherein, if the communications device determines that it has transmitted as the third signal a plurality of consecutive transmission units of a same transport block, the communications device determines the acknowledgement identifier based on an index of a first or a last of the plurality of consecutive transmission units.

21. A method according to claim 1, wherein the third signal is a final signal transmitted by the communications device before the communications device transitions into an inactive state.

22.-40. (canceled)

41. An infrastructure equipment in a cell of a wireless communications network configured to transmit data or receive data in a cell of a wireless communications network, the infrastructure equipment comprising
transceiver circuitry configured to transmit signals and receive signals via a wireless access interface provided by the wireless communications network, and
controller circuitry configured in combination with the transceiver circuitry
to receive a first signal comprising a random access preamble and a first portion of uplink data,
to transmit, in response to receiving the first signal, a second signal comprising a random access response, and
to receive a third signal comprising a second portion of uplink data in response to the second signal,
wherein the second signal further comprises an indication of downlink radio resources forming a Physical Downlink Shared Channel, PDSCH, reserved for the transmission of one or more acknowledgements or negative acknowledgements, ACK/NACKs, by the infrastructure equipment, wherein one of the one or more ACK/NACKs from the infrastructure equipment is for transmission in response to the reception of the third signal.

42. (canceled)

43. A communications device configured to transmit data or receive data, the communications device comprising
transceiver circuitry configured to transmit signals and receive signals via a wireless access interface, and
controller circuitry configured in combination with the transceiver circuitry
to determine an acknowledgement identifier in accordance with predefined information known by the communications device,
to transmit a first signal comprising uplink data, and
to monitor for reception of a Downlink Control Information, DCI, signal having the determined acknowledgement identifier,
wherein either: the DCI signal comprises an indication of downlink radio resources forming a Physical Downlink Shared Channel, PDSCH, reserved for the transmission of one or more acknowledgements or negative acknowledgements, ACK/NACKs, wherein one of the one or more ACK/NACKs is for reception by the communications device in response to the transmission of the first signal; or the DCI signal comprises one or more ACK/NACKs, wherein one of the one or more ACK/NACKs is for reception by the communications device in response to the transmission of the first signal.

44.-56. (canceled)
